(19) United States
(12) Patent Application Publication
(10) Pub. No.: US 2026/0311560 A1
(43) Pub. Date: Oct. 8, 2026

(54) METHOD AND SYSTEM FOR PROCESSING CASINO TABLE JACKPOT GAME

(71) Applicant: JS TRADING INC., Seoul (KR)

(72) Inventor: Su Il KIM, Seoul (KR)

(73) Assignee: JS TRADING INC., Seoul (KR)

(21) Appl. No.: 19/398,692

(22) Filed: Nov. 24, 2025

(30) Foreign Application Priority Data
Apr. 8, 2025 (KR) 10-2025-0045176

(51) Int. Cl. G07F 17/32

(52) U.S. Cl. CPC G07F 17/3258

(57) ABSTRACT

According to an embodiment of the present invention, there is provided a method by which a jackpot game processing server processes a casino table jackpot game, the method including: (a) randomly determining a jackpot winning amount; (b) accumulating betting amounts, transmitted from respective game devices located in a plurality of casinos, as a cumulative betting amount; (c) selecting a user, who places a bet when the cumulative betting amount reaches the winning amount, as a winner; and (d) determining a percentage of the winning amount to be distributed to one or more accompanying users who participate in the casino table jackpot game while occupying the same table as the winner.

### CROSS-REFERENCE TO RELATED APPLICATION

This application claims the benefit of Korean Patent Application No. 10-2025-0045176 filed on Apr. 8, 2025, which is hereby incorporated by reference herein in its entirety.

### BACKGROUND

### 1. Technical Field

The present invention relates generally to a method and system for processing a casino table jackpot game, and more particularly to a method and system that enable a specific percentage of a winning amount to be distributed to casino users at the same table when a specific user wins a jackpot game.

### 2. Description of the Related Art

Progressive jackpot games utilize additional betting amounts, unlike typical casino games utilizing general betting amounts. For example, the jackpot amount of a progressive jackpot increases continuously until a winner is selected, and is then reset when a winner is selected.

A winning change for a progressive jackpot is based on random probability. For example, in a poker card game, a progressive jackpot player may be selected as a winner when the progressive jackpot player holds any one of a predetermined number of high-scoring cards.

There are various types of known methods for selecting winners in conventional progressive jackpot games.

However, determining the winner of a progressive jackpot game through a high score or a sequence meeting predetermined conditions in a slot machine or the poker game described above is far from the selection of a winner at completely random probability, making it difficult to generate significant anticipation and excitement among players.

Therefore, there is a demand for the development of a method for processing a jackpot win and distributing a winning amount that may generate additional excitement.

### SUMMARY

The present invention is intended to overcome the problems of the prior art.

An object of the present invention is to enable jackpot games having different winning probabilities to be provided in a plurality of casinos.

An object of the present invention is to increase interest in a jackpot game and also encourage high participation by distributing profits to other users who sit at the same table as a winner.

An object of the present invention is to increase participation in a jackpot game by distributing a winning amount to a winner in inverse proportion to his or her winning probability when distributing the winning amount to users at the same table, thereby providing each user with the expectation of a high winning amount even with a low probability.

Objects of the present invention are not limited to the above-described objects, and other objects not mentioned will be clearly understood from the following description.

According to an aspect of the present invention, there is provided a method by which a jackpot game processing server processes a casino table jackpot game, the method including: (a) randomly determining a jackpot winning amount; (b) accumulating betting amounts, transmitted from respective game devices located in a plurality of casinos, as a cumulative betting amount; (c) selecting a user, who places a bet when the cumulative betting amount reaches the winning amount, as a winner; and (d) determining a percentage of the winning amount to be distributed to one or more accompanying users who participate in the casino table jackpot game while occupying the same table as the winner.

Step (d) may include distributing X % and Y % of the winning amount to the winner and the accompanying users, respectively, and X may be inversely proportional to a winning probability of a casino in which the winner was selected.

The winning probability of the casino in which the winner was selected may be obtained by dividing the number of users participating in a jackpot game in the casino in which the winner was selected by the number of users participating in the jackpot game in all the plurality of casinos.

According to an embodiment of the present invention, it may be possible to enable jackpot games having different winning probabilities to be provided in a plurality of casinos.

According to an embodiment of the present invention, it may be possible to increase interest in a jackpot game and also encourage high participation by distributing profits to other users that sit at the same table as a winner.

According to an embodiment of the present invention, it may be possible to increase participation in a jackpot game by distributing a winning amount to a winner in inverse proportion to his or her winning probability when distributing the winning amount to users at the same table, thereby providing each user with the expectation of a high winning amount even with a low probability.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a diagram schematically illustrating the configuration of a system for processing a casino table jackpot game according to an embodiment of the present invention; and

FIG. 2 is a diagram illustrating the internal configuration of a jackpot game processing server according to an embodiment of the present invention.

### DETAILED DESCRIPTION

The following detailed description of the present invention will be given with reference to the accompanying drawings, which illustrate specific embodiments in which the present invention may be practiced. These embodiments are described in sufficient detail to enable those skilled in the art to practice the present invention. It should be understood that various embodiments of the present invention are different from each other but are not necessarily mutually exclusive. For example, specific shapes, structures, and characteristics described herein may be implemented in other embodiments without departing from the spirit and scope of the present invention. Furthermore, it should be understood that the positions or arrangement of individual components within each disclosed embodiment may be modified without departing from the spirit and scope of the present invention. Accordingly, the following detailed description is not intended to be limiting, and the scope of the present invention is defined only by the attached claims, together with the full scope of equivalents to which such claims are entitled, when appropriately described. Similar reference numerals in the accompanying drawings designate the same or similar components throughout various aspects.

Hereinafter, embodiments of the present invention will be described in detail with reference to the accompanying drawings so that those skilled in the art may easily implement the present invention.

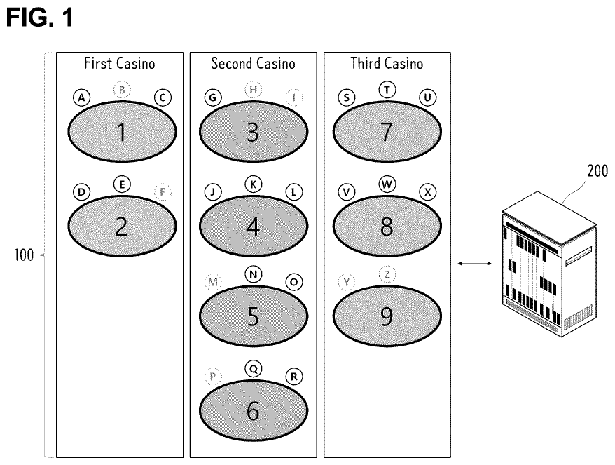

FIG. 1 is a diagram schematically illustrating the configuration of a system for processing a casino table jackpot game according to an embodiment of the present invention.

Referring to FIG. 1, the system for processing a casino table jackpot game according to an embodiment may include a game device 100 and a jackpot game processing server 200.

The game device 100 and the jackpot game processing server 200 may communicate with each other via a communication network, such as a mobile communication network, a Local Area Network (LAN), a Metropolitan Area Network (MAN), a Wide Area Network (WAN), the World Wide Web (WWW), or a Wireless Fidelity (WiFi) network. Furthermore, the game device 100 and the jackpot game processing server 200 may communicate using the Game to System (G2S) protocol, the Slot Account System (SAS) protocol, or the System to System (S2S) protocol.

The game device 100 may be installed at each of a plurality of tables in a plurality of casinos.

Events occurring on each game device 100 may be transmitted to the jackpot game processing server 200. For example, betting amount information generated on each game device 100 may be transmitted to the jackpot game processing server 200 in real time.

Each game device 100 may include a sensor configured to detect a betting amount or betting chips on a game table, and a communication module configured to transmit the detected information to the jackpot game processing server 200. Since the sensor and the communication module may be implemented using conventional techniques, detailed descriptions thereof will be omitted here.

Furthermore, each game device 100 has information about a casino in which it is located. When the game device 100 communicates with the jackpot game processing server 200, it may also transmit the information about a casino (e.g., identification information).

Casino users may enjoy games while sitting on or occupying the seats of respective game devices 100. The respective seats available to casino users are assigned seat identifiers A to Z. Furthermore, the casino users may place bets by inserting or placing chips in the betting slots or betting areas of the respective game devices 100. They may also place additional bets to participate in mystery jackpot games.

Embodiments of the present invention should be understood as encompassing both an embodiment that places bets only on a main game such as poker, blackjack, baccarat, or the like, and an embodiment that places additional bets for participation in a mystery jackpot game.

The casino table jackpot game processing server 200 according to the embodiment performs operations such as setting a winning amount for a casino table jackpot game, accumulating the betting amounts transmitted from respective game devices 100, determining whether a mystery game has been won based on a cumulative betting amount, and selecting a winner.

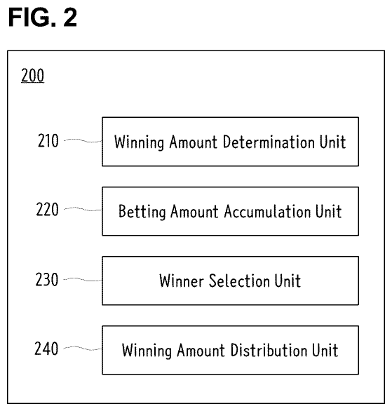

Hereinafter, the detailed operation of the jackpot game processing server 200 will be described with reference to FIGS. 1 and 2.

FIG. 2 is a diagram illustrating the internal configuration of a jackpot game processing server according to an embodiment of the present invention.

Referring to FIG. 2, a jackpot game processing server 200 according to an embodiment may include a winning amount determination unit 210, a betting amount accumulation unit 220, a winner selection unit 230, and a winning amount distribution unit 240.

The winning amount determination unit 210, the betting amount accumulation unit 220, the winner selection unit (230), and the winning amount distribution unit 240 may be program modules or hardware capable of communicating with external devices. These program modules or hardware may be included in the jackpot game processing server 200 or another device capable of communicating with the jackpot game processing server 200 in the form of an operating system, application program modules, or other program modules, and may be physically stored on various known memory devices. Meanwhile, these program modules or hardware encompass, but are not limited to, routines, subroutines, programs, objects, components, data structures, and/or the like that perform specific tasks or execute specific abstract data types, to be described below, according to the present invention.

The winning amount determination unit 210 according to an embodiment serves to randomly determine the winning amount of a jackpot game. In an embodiment, the winning amount of a jackpot game may be determined based on a variable output by a random number generator (RNG).

The betting amount accumulation unit 220 serves to receive information about a betting amount for a casino game or a casino table jackpot game from each game device 100 and continuously accumulate pieces of information about a betting amount. As will be described below, when a cumulative betting amount reaches or exceeds a winning amount determined by the winning amount determination unit 210, the winner of the casino table jackpot game is selected. Once the winner of the jackpot game has been selected, information about the cumulative betting amount is reset.

According to an embodiment, the pieces of information about a betting amount received from a plurality of game devices 100 at a plurality of tables located in a plurality of casinos (first to third casinos) may be accumulated together.

Furthermore, according to an embodiment, even when users occupy the same casino table, they may decide whether to participate in a jackpot game. For example, each of the users may place a separate bet for a casino table jackpot game, and only one or more users who participate in this betting may become candidates for the winner of the casino table jackpot game and winning amount distribution targets to be described later.

The winner selection unit 230 according to an embodiment performs the process of selecting a jackpot winner when the cumulative betting amount obtained by the betting amount accumulation unit 220 reaches or exceeds the winning amount determined by the winning amount determination unit 210. A method of selecting a winner is to select a user who has placed a bet when the cumulative betting amount is equal to or higher than the winning amount. Notification of the selected winner may be provided by visually indicating the seat occupied by the winner or by audibly notifying the winner of the selection. For this purpose, a display unit (e.g., an LED or other display) for visual notification or a speaker may be provided at each seat or in any area within a corresponding casino.

The winning amount distribution unit 240 serves to distribute a winning amount to other users participating in a jackpot game at a table that is occupied by the user selected as the winner.

In the example shown in FIG. 1, it is assumed that first, second, and third casinos are provided with two tables, four tables, and three tables, respectively, and the respective tables are assigned identification numbers ranging from 1 to 9. Each of the tables may accommodate up to three users.

In the first casino, users A and C participate in a jackpot game at table 1, and users D and E participate in the jackpot game at table 2.

In the second casino, user G participates in the jackpot game at table 3, users J, K, and L participate in the jackpot game at table 4, users N and O participate in the jackpot game at table 5, and users Q and R participate in the jackpot game at table 6.

In the third casino, users S, T, and U participate in the jackpot game at table 7, users V, W, and X participate in the jackpot game at table 8, and no one participates in the jackpot game at table 9.

That is, users A, C, D, and E (a total of four persons) participate in the first casino, users G, J, K, L, N, O, Q, and R (a total of eight persons) participate in the second casino, and users S, T, U, V, W, and X (a total of six persons) participate in the third casino. The total number of participants is 18.

The jackpot game winning probabilities for the respective casinos are as follows:
For first casino: 4/18=2/9
For second casino: 8/18=4/9
For third casino: 6/18=1/3

In other words, the probability of a winner in each of the casinos is calculated by dividing the number of users participating in the jackpot game in that casino by the total number of users participating in the jackpot game across all the casinos.

Meanwhile, as described above, the winning amount is also distributed to other participants at the table that is occupied by the user selected as a winner, so that the probability that each of the users wins the jackpot game or receives a share of the winning amount is as follows:
For users A to E: 2/18=1/9
For user G: 1/18
For users J to L: 3/18=1/6
For users N to R: 2/18=1/9
For users S to X: 3/18=1/6

In other words, the probability that a specific user wins the jackpot game or receives a share of the winning amount is calculated by dividing the number of users participating in the jackpot game at the table occupied by the specific user by the number of users participating in the jackpot game across all the plurality of casinos.

That is, as the number of users participating in the jackpot game at the table increases, the probability of winning the jackpot game or receiving a share of the winning amount at that table increases.

When the winning amount is distributed, X % of the winning amount is distributed to the winner, and Y % of the winning amount is distributed to the other participating users at the corresponding table. Furthermore, X>Y, where Y=(100−X)/(n−1). In this equation, n denotes the number of users participating in the jackpot game at the winner's table.

Meanwhile, the value of X may vary depending on the winning probability of the casino in which the winner was selected, the winning probability of the winner, and the time t for which the winner has occupied his or her seat.

According to an embodiment, the value of X may be set as follows:

$$X = k \cdot \frac{t}{r 1 \cdot r 2}$$

In the above equation, r1 and r2 denote values proportional to the winning probability of the casino in which the winner was selected and the winning probability of the winner, respectively, and k is a constant. The value of X may be equal to or larger than a first threshold value equal to or larger than 0, and may be smaller than or equal to a second threshold value smaller than or equal to 100. When the value of X is smaller than the first threshold value, X may be set to the first threshold value. When the value of X exceeds the second threshold value, X may be set to the second threshold value.

The time for which a user has occupied each seat may be obtained by analog measurement, or may be obtained by measuring continuous occupancy via a sensor installed at the seat. Furthermore, whether a user is participating in the jackpot game at each seat may be detected from the game device 100, and may be obtained as cumulative time data indicating uninterrupted, continuous participation.

The foregoing description of the present invention is intended for illustrative purposes only, and those skilled in the art will readily appreciate that modifications toward other specific forms may be made without altering the technical spirit or essential characteristics of the present invention. Accordingly, the embodiments described above should be understood as illustrative in all respects and not restrictive. For example, each component described as being in a single form may be implemented in a distributed manner, and similarly, components described as being in a distributed form may be implemented in a combined manner.

The scope of the present invention is defined by the attached claims, and all modifications or variations derived from the meanings and scope of the claims and their equivalents should be deemed to fall within the scope of the present invention.

1. A method by which a jackpot game processing server processes a casino table jackpot game, the method comprising:
(a) randomly determining a jackpot winning amount;
(b) accumulating betting amounts, transmitted from respective game devices located in a plurality of casinos, as a cumulative betting amount;
(c) selecting a user, who places a bet when the cumulative betting amount reaches the winning amount, as a winner; and
(d) determining a percentage of the winning amount to be distributed to one or more accompanying users who participate in the casino table jackpot game while occupying a same table as the winner;
wherein step (d) comprises distributing X % and Y % of the winning amount to the winner and the accompanying users, respectively:
wherein X is computed by the following equation:
$$X = k \cdot \frac{t}{r 1 \cdot r 2}$$
where r1 and r2 denote values proportional to a winning probability of a casino in which the winner is selected and a winning probability of the winner, respectively, k is a constant, t is a time for which the winner has occupied his or her seat, and X is restricted to a value between a first threshold value larger than 0 and a second threshold value smaller than 100, and
where r1 is a value obtained by dividing a number of participants in the casino table jackpot game in the same casino as the winner by a total number of participants in the casino table jackpot game across the plurality of casinos; and
wherein Y is defined by (100−X)/(n−1), and n is a number of the accompanying users.

2-3. (canceled)
